(19) United States
(12) Patent Application Publication
(10) Pub. No.: US 2005/0091447 A1
(43) Pub. Date: Apr. 28, 2005

(54) Information recording and reproducing device

(75) Inventors: Toshitaka Kuma, Anpachi-Gun (JP); Tsuyoshi Yamamoto, Ota-Shi (JP); Katsumi Hattori, Kiryu-Shi (JP); Masato Fuma, Ichinomiya-Shi (JP); Hiroshi Watanabe, Anpachi-Gun (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 10/972,511

(22) Filed: Oct. 26, 2004

(30) Foreign Application Priority Data
Oct. 28, 2003 (JP) 2003-366842 (P)

(51) Int. Cl. G06F 12/00

(52) U.S. Cl. 711/112

(57) ABSTRACT

The present invention aims at providing an information recording and reproducing device which cannot only maintain interchangeability with the reproducing dedicated type media but also realize enhancement of reliability of media based on spare processing as appropriate. A spare area is selectively secured in accordance with whether or not an instruction indicating that a spare area is secured is detected. The instruction indicating that a spare area is secured, for example, is issued by utilizing a method in which a user directly selects whether or not data is recorded in a high reliability mode to set the selection results, or the like. When first recording processing is started, firstly, after an area for recording of a data block for first lead-in is secured in an unrecorded area, first user data is recorded from a position next thereto. When a reproducing defect is detected in verifying reproducing of recording data, a first spare area is secured in an outer periphery of a write once type disc and a spare processing object data block is recorded therein.

### BACKGROUND OF THE INVENTION

1. Field of the Invention

The present invention relates in general to an information recording and reproducing device, and more particularly to an information recording and reproducing device which is suitable for recording and reproducing information in and from a write once type optical disc.

2. Related Background Art

Recording media (optical discs) which are currently widely used can be roughly classified into reproducing dedicated type media such as a CD-ROM and a DVD-ROM, rewrite type media such as a CD-RW and a DVD-RW, and write once type media such as a CD-R, a DVD−R and a DVD+R. Of those recording media, the rewrite type media such as a CD-RW and a DVD-RW can be rewritten several thousands of times and have characteristic features in that high reliability is ensured owing to the provision of a spare area, and the storage capacity is increased owing to the high recording density. On the other hands, in the case of the write once type media such as a CD-R, a DVD−R and a DVD+R, information can be written therein only once. However, the write once type media have characteristic features in that they are more inexpensive than the rewrite type media and also maintain high interchangeability with the reproducing dedicated type media such as a CD-ROM and a DVD-ROM.

In order to maintain perfect interchangeability with the reproducing dedicated type media, such a spare area as provided in the rewrite type media is not provided in any of the conventional write once type media. Thus, when data is failed to be written during the recording, a disc is damaged, data is lost owing to a secular change, and so forth, such situations lead to a recording error or a reproducing error. As a result, there is encountered a problem in that the reliability of the disc is impaired. This problem may be more remarkable as an increase in storage capacity will further promoted and hence a unit price of the medium will be more expensive in the feature.

On the other hand, an information recording and reproducing device in which a spare packet area is provided in the most outer periphery of a write once type medium to execute spare processing without wasting any of recording areas is proposed in JP 11-066751 A.

However, in such an information recording and reproducing device, a spare packet area is always provided in the most outer periphery of the medium, leading to a problem in that the perfect interchangeability with the reproducing dedicated type media, as the characteristic feature of the write once type media, cannot be maintained any more. That is, when a disc diameter of the write once type medium is the same as that of the reproducing dedicated type medium, the provision of the spare area impairs the capacity interchangeability. On the other hand, in order to maintain the capacity interchangeability, the disc diameter is forced to be increased in correspondence to the capacity of the spare area. As a result, it is impossible to maintain the perfect interchangeability with the reproducing dedicated type media in terms of a physical format.

### SUMMARY OF THE INVENTION

It is an object of the present invention to provide an information recording and reproducing device which cannot only maintain interchangeability with the reproducing dedicated type media but also realize enhancement of reliability of media based on spare processing as appropriate.

When data storage or backup of media is supposed as an application of the write once type media, it is very rare to fully use up a data capacity of the write once type medium. Thus, in many cases, the processing for closing the write once type medium (finalizing) is executed while some excess data capacity is left.

In the present invention, in the write once type medium, a spare area is set in an excess area of a disc in a selectable form. As a result, with maintaining high interchangeability with the reproducing dedicated type media, the enhancement of reliability of the media based on the spare processing is also to be realized.

According to a first aspect of the present invention, an information recording and reproducing device for recording and reproducing information in and from a write once type recording medium includes:
recording means for recording information in the write once type recording medium;
reproducing means for reproducing information from the write once type recording medium;
propriety determination means for determining propriety of recording based on a reproducing state when the information recorded by the recording means is reproduced by the reproducing means;
instruction detection means for detecting an instruction indicating to secure a spare area;
spare area securing means for, when the recording is determined as being improper by the propriety determination means and when the instruction to secure the spare area is detected by the instruction detection means, securing a spare area; and
recording control means for, when the recording is determined as being improper by the propriety determination means and when the instruction to secure the spare area is detected by the instruction detection means, spare-recording the information the recording of which is determined as being improper in the spare area secured by the spare area securing means,
in which the spare area securing means secures the spare area in an area where interchangeability on a format with a reproducing dedicated type recording medium can be maintained.

In the first aspect of the invention, it can be configured that when data reproduced by the reproducing means cannot be reproduced, or when an amount of error equal to or larger than a reference value is contained in information reproduced by the reproducing means, the propriety determination means determines that the recording is improper.

According to a second aspect of the present invention, an information recording and reproducing device for recording and reproducing information in and from a write once type recording medium includes:
recording medium for recording information in the write once type recording medium;
reproducing means for reproducing information from the write once type recording medium;
error correction means for performing error-correction on the information reproduced by the reproducing means;
propriety determination means for determining propriety of recording based on a reproducing state when the information recorded in the write once type recording medium is reproduced by the reproducing means;
instruction detection means for detecting an instruction indicating to secure a spare area;
spare area securing means for, when the recording is determined as being improper by the propriety determination means and when the instruction to secure the spare area is detected by the instruction detection means, securing a spare area; and
recording control means for, when the recording is determined as being improper by the propriety determination means and when the instruction to secure the spare area is detected by the instruction detection means, spare-recording the information obtained by performing error-correction on the information the recording of which is determined as being improper in the spare area secured by the spare area securing means,
in which the spare area securing means secures the spare area in an area where interchangeability on a format with a reproducing dedicated type recording medium can be maintained.

In the second aspect of the invention, it can be configured that when an amount of error equal to or larger than a reference value is contained in information reproduced by the reproducing means, and the error in the reproduced information can be corrected by the error correction means, the propriety determination means determines that the recording is improper.

In the first and the second aspects of the invention, it can be configured that the spare area securing means determines whether or not the spare recording can be carried out for a spare area which is newly secured or which is already secured, and when it is determined that the spare recording cannot be carried out, secures a new spare area in an area where interchange ability on a form at with are producing dedicated type recording medium can be maintained.

### BRIEF DESCRIPTION OF THE DRAWINGS

Above and other objects and novel features of the present invention will be more perfectly made clear by reading the following description of preferred embodiments with reference to the accompanying drawings, wherein:

FIG. 1 shows a configuration of an optical information recording and reproducing device according to an embodiment mode of the present invention;

FIG. 2 shows a structure of a write once type optical disc according to the embodiment mode of the present invention;

FIG. 3 shows a recording/reproducing processing flow according to a first embodiment of the present invention;

FIG. 4 shows an operational flow chart of first recording processing;

FIG. 5 shows an operational flow chart of the first recording processing;

FIG. 6A to 6c shows a state of data mapping constituted by the first recording processing;

FIG. 7 shows an operational flow chart of second recording processing;

FIG. 8A to 8c shows a state of data mapping constituted by the second recording processing;

FIG. 9 shows an operational flow chart of first reproducing processing;

FIG. 10 shows an operational flowchart of the first reproducing processing;

FIG. 11 shows an operational flow chart of second reproducing processing;

FIG. 12 shows an operational flow chart of the second reproducing processing;

FIG. 13 shows a recording/reproducing processing flow according to a second embodiment of the present invention;

FIG. 14 shows an operational flow chart of third recording processing;

FIG. 15 shows an operational flow chart of the third recording processing;

FIG. 16A to 16D shows a state of data mapping constituted by the third recording processing;

FIG. 17 shows an operational flow chart of fourth recording processing;

FIG. 18A to 18D shows a state of data mapping constituted by the fourth recording processing;

FIG. 19 shows an operational flow chart of third reproducing processing;

FIG. 20 shows an operational flow chart of the third reproducing processing;

FIG. 21 shows an operational flow chart of fourth reproducing processing; and

FIG. 22 shows an operational flow chart of the fourth reproducing processing.

### DESCRIPTION OF PREFERRED EMBODIMENTS

An embodiment mode of the present invention will hereinafter be described in detail with reference to the accompanying drawings. Note that the following embodiment mode is merely an example of the present invention, and hence does not intend to limit the scope of the present invention.

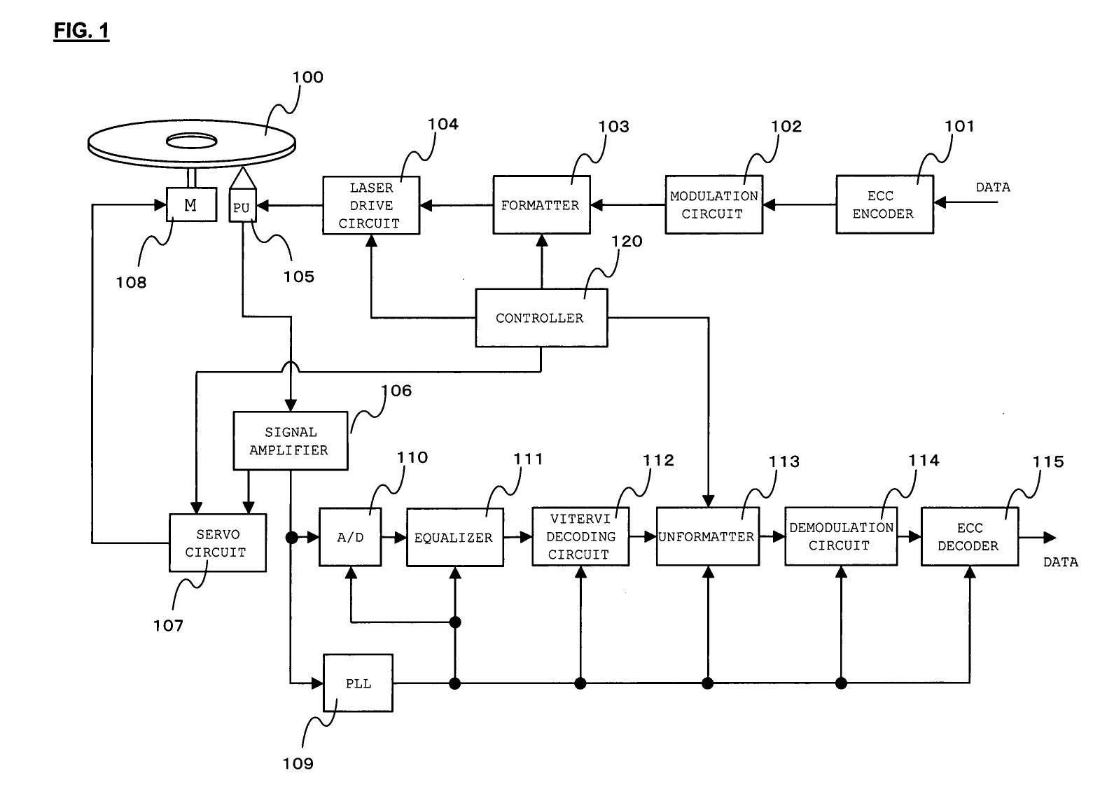

First of all, FIG. 1 shows a circuit block diagram of an information recording and reproducing device for recording and reproducing information in and from a write once type disc.

As shown in the figure, the information recording and reproducing device of this embodiment mode includes an error correction code (ECC) encoder 101, a modulation circuit 102, a formatter 103, a laser drive circuit 104, an optical pickup 105, a signal amplifier 106, a servo circuit 107, a spindle motor 108, a phase-locked loop (PLL) 109, an A/D conversion circuit 110, an equalizer 111, a vitervi decoding circuit 112, an unformatter 113, a demodulation circuit 114, an ECC decoder 115, and a controller 120. In the figure, reference numeral 100 designates a write once type optical disc.

The ECC encoder 101 adds an error correction code such as a read Solomon code to user data inputted thereto to output the resultant data to the modulation circuit 102. The modulation circuit 102 carries out modulation such as EFF modulation, EFMP modulation or RLL (1.7) modulation for recording data and the error correction code so as to put a limitation to the shortest or longest data length of the recording data, or so as to suppress low frequencies to control a fluctuation of a D.C. component. The formatter 103 processes the modulated recording data so as to meet a physical format of the write once type disc in accordance with a timing signal from the controller 120 to output the resultant data to the laser drive circuit 104. The laser drive circuit 104 controls the optical pickup 105 so as to emit a laser beam with a recording electric power optimal for the write once type disc based on the recording signal from the formatter 103.

A signal reproduced with the optical pickup 105 is amplified and arithmetically operated in the signal amplifier 106. The servo circuit 107 controls rotation of the spindlemotor 108, and a tracking mechanism and a focusing mechanism of the optical pickup 105, based on the signal from the signal amplifier 106. The PLL 109 generates a clock signal synchronous with reproduced data using a reproduced RF signal outputted from the signal amplifier 106 to output the resultant clock signal to each of corresponding circuits. The A/D conversion circuit 110 samples the reproduced RF signal synchronously with the clock signal from the PLL 109. Thus, the A/D conversion circuit 110 converts the analog signal into digital data. The equalizer 111 equalizes the digital data into a signal having a predetermined waveform to output the resultant signal to the vitervi decoding circuit 112. The vitervi decoding circuit 112 selects the most probable data stream based on the results of arithmetic operation of a Hamming distance to output binary data. The unformatter 113 removes the data which is obtained through the processing in the formatter 103 based on the timing signal from the controller 120 to extract the user data and the error correction code. The demodulation circuit 114 demodulates the data which is obtained through the modulation in the modulation circuit 102 to output the demodulated data to the ECC decoder 115. The ECC decoder 115 carries out error detection and error correction for the user data using the error correction code to output the user data after completion of the correction to a circuit in a subsequent stage.

The controller 120 receives the various commands for recording and reproducing from a central processing unit (CPU) and a microprocessor unit (MPU) to generate the various timing signals and control signals in order to control the portions. Note that a control operation during the recording/reproducing in the controller 120 will be described later in detail.

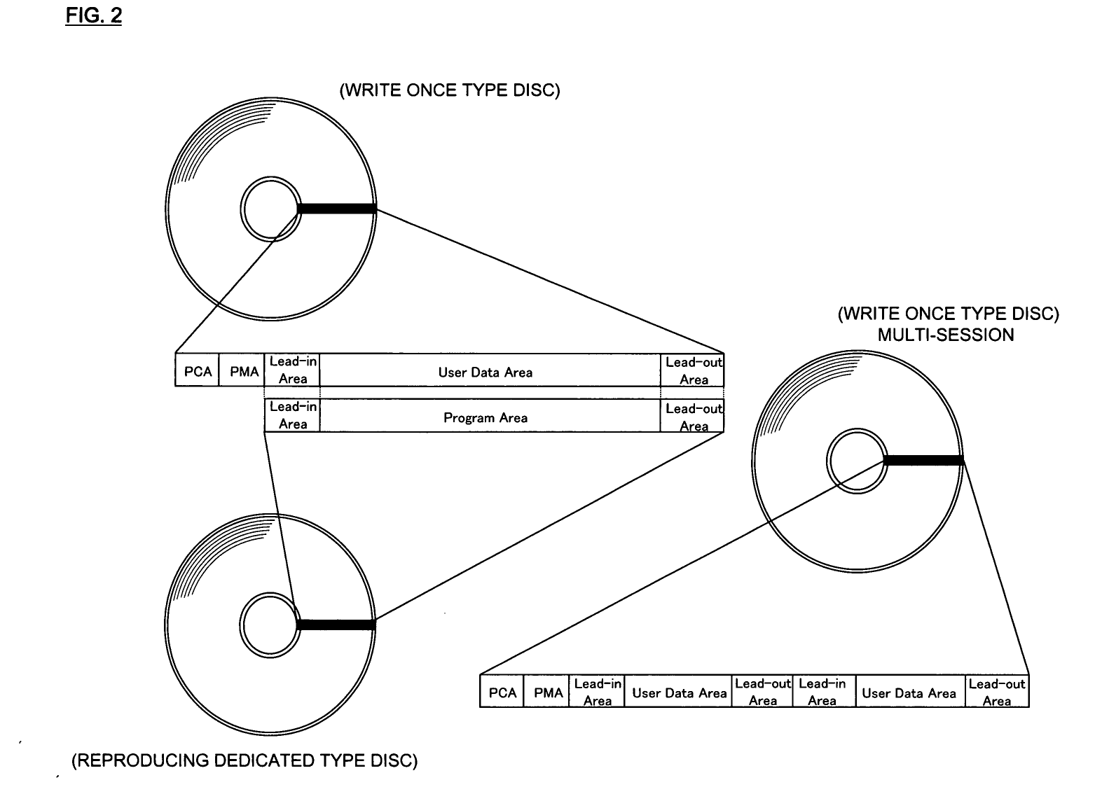

FIG. 2 is a view showing disc allocation of the write once type disc and a reproducing dedicated type disc. Note that in FIG. 2, disc allocation when a plurality of disc structures are virtually realized on one sheet of disc (the disc allocation is called a multi-session or a multi-border (hereinafter referred to as a multi-session for short)) is also simultaneously shown.

As shown in the figure, the reproducing dedicated type disc includes a lead-in area indicating the beginning of program data, a program area having program data stored therein, and a lead-out area indicating the end of the program area.

On the other hand, the write once type disc includes a recording area where a lead-in area indicating the beginning of a user data area, the user data area as a recording area for user data and a lead-out area indicating the end of the user data area can be secured in the form of being physically, logically and perfectly interchangeable with the reproducing dedicated type disc. In addition, a power calibration area (PCA) which is used to determine a recording or reproducing laser power, and a program memory area (PMA) in which information, such as a recording condition and a write once recording pointer, peculiar to the write once type medium are provided in the front of the position of the lead-in area of the reproducing dedicated type disc.

Moreover, in the multi-session of the write once type disc, a plurality of sets of lead-in areas, user data areas and lead-out areas are secured, whereby the constitution can be carried out just as if a plurality of discs are present on one sheet of disc.

In this embodiment mode, a spare area is specially secured in accordance with ON/OFF of the spare processing. Then, when an error at a spare processing operation level is detected in a data block after recording, the data in this data block is spare-recorded in the spare area. At this time, information on the spare, e.g., information representing a correlation between a recording position of a spare source and a recording position of a spare destination, is recorded/updated in a predetermined area on the disc such as an idle area of the lead-in area.

An operation during the recording/reproducing including such spare processing will hereinafter be described. Note that in the following embodiments, the spare processing is executed in the reproducing operation as well in the recording operation.

### A. First Embodiment

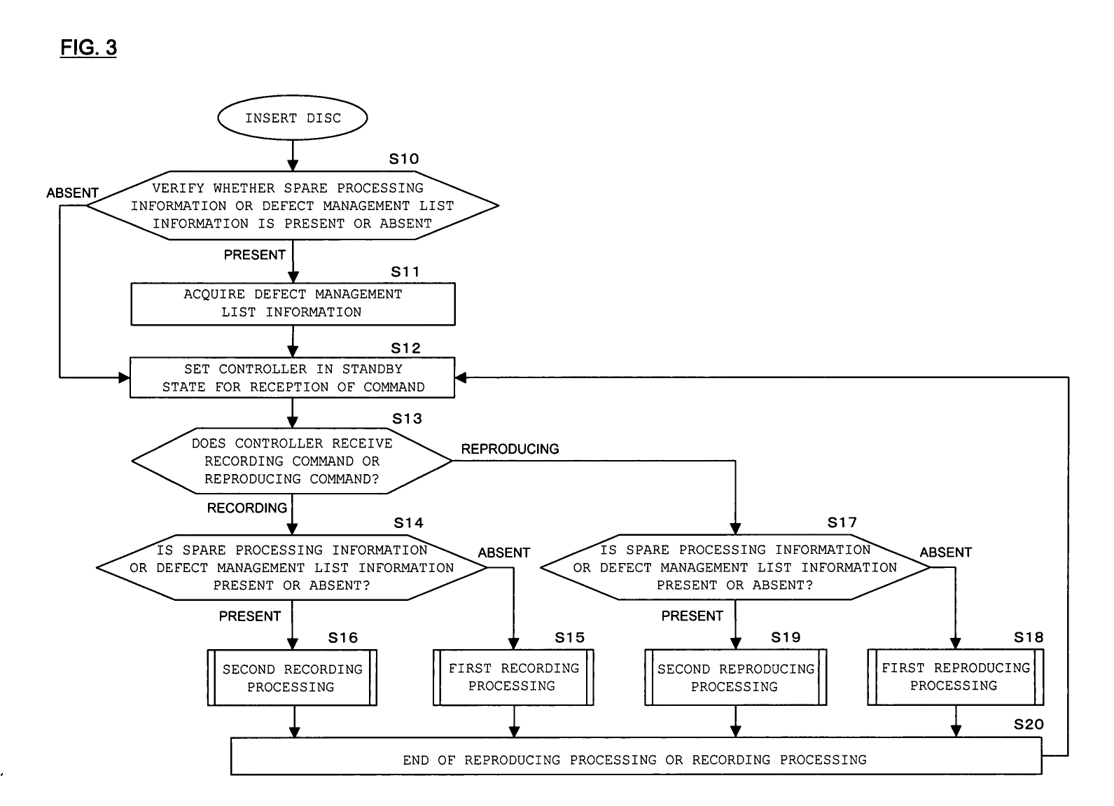

FIG. 3 shows a flow chart during the recording/reproducing operation of the information recording and reproducing device in a first embodiment.

When the write once type disc is inserted into the information recording and reproducing device, first of all, there is verified the presence or absence of the spare processing information containing the presence or absence of a spare and information on a spare, or the presence or absence of the defect management list information having a relationship between a spare source and a spare destination recorded therein (S10). In this embodiment, when it is verified that there is a spare, the defect management list information is recorded in the lead-in area. Thus, it is verified in S10 whether or not the defect management list information is recorded in the lead-in area. When it is verified in S10 that the defect management list information is recorded in this area, the defect management list information is acquired in S11. Then, the operation state of the controller 120 becomes a standby state of reception of a command (S12).

Thereafter, when the controller 120 receives the recording command (S13), either first recording processing (S15) or second recording processing (S16) is executed in accordance with the presence or absence of the spare processing information or the defect management list information (S14). The details of the processing will be described later. Then, when the recording processing is completed, the controller 120 is informed of completion of the recording processing (S20).

On the other hand, when the controller 120 receives the reproducing command (S13), either first reproducing processing (S18) or second reproducing processing (S19) is executed in accordance with the presence or absence of the spare processing information or the defect management list information (S17). The details of the processing will be described later. Then, when the reproducing processing is completed, the controller 120 is informed of completion of the reproducing processing (S20).

<First Recording Processing>

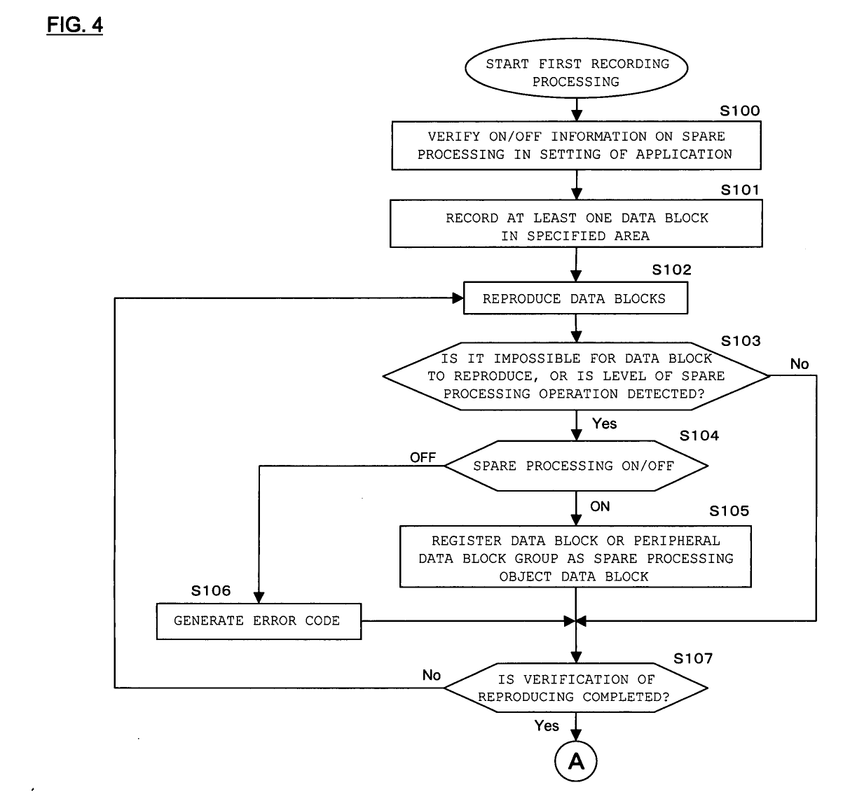

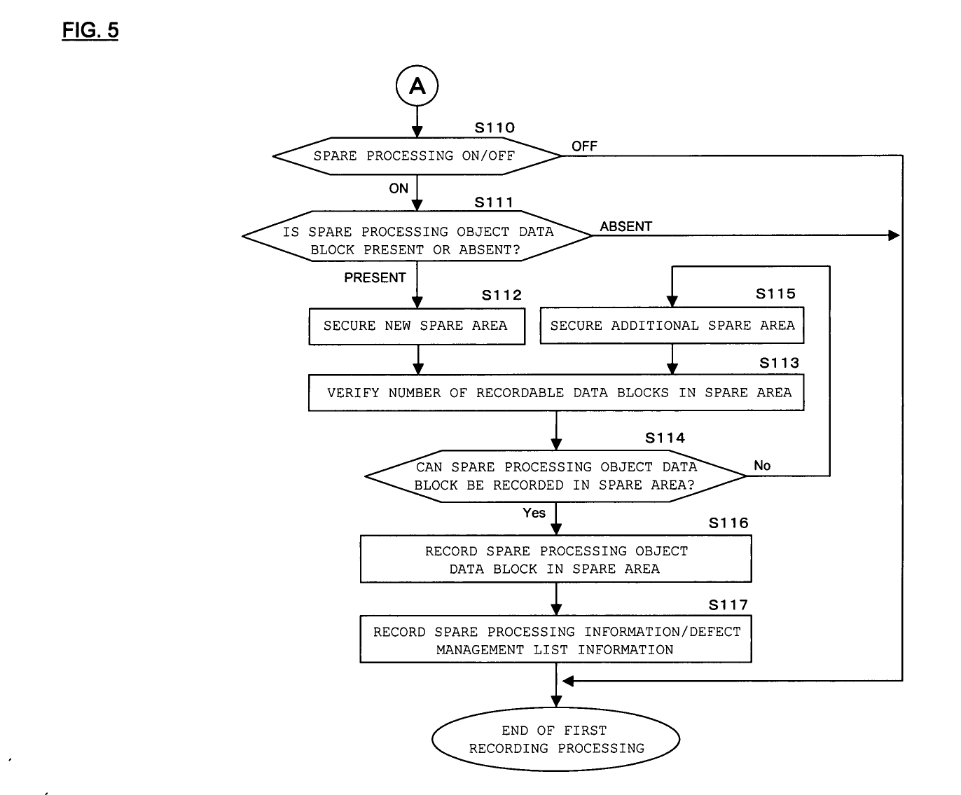

FIGS. 4 and 5 are flow charts each showing an operation of first recording processing (S15) shown in FIG. 3. In this processing, it is supposed that the recording failure, and the data loss due to a disc defect occur. Thus, the processing to verify whether or not the recording is proper is executed whenever a predetermined number of data blocks are recorded. Note that when such verification is not carried out, the reproducing verification processing and the spare processing for the recorded data will be executed in the reproducing processing as will be described later.

Referring now to FIG. 4, when first recording processing is started to be executed, first, the controller 120 verifies ON/OFF information on spare processing in setting of an application for an upper application (S100). Here, the ON/OFF information on the spare processing is flag information representing whether or not the spare processing is executed. For example, the ON/OFF information on the spare processing is set in the information recording and reproducing device by utilizing a method in which a user sets the ON/OFF information by selecting directly whether or not the recording is carried out in a high reliability mode, a method in which an application automatically sets the ON/OFF information based on the judgment of a remaining recording capacity and a transfer data capacity of a medium, a method in which an application sets the ON/OFF information based on the results of inquiry made for a user, or the like.

Next, at least one data block is recorded in a specified area (S101), and the recorded data blocks are then reproduced (S102) to verify whether or not each data block is unable to be reproduced, or whether or not an amount of error in the reproduced data block exceeds a predetermined amount of error (S103). Hence, the amount of error in the data block, for example, can be detected by referring to a correction flag of an error correction code in the ECC decoder 115.

When it is judged in the verification processing in S103 that the reproducing of the data block concerned is satisfactory, next, it is determined whether or not the verification for reproducing of all the recorded data blocks is ended (S107). When it is determined that there is the unverified data block, the operation is returned back to the processing in S102 to verify the reproducing of a next data block.

On the other hand, when it is judged in the verification processing in S103 that the reproducing of the data block concerned is not satisfactory, it is determined whether the ON/OFF information on the spare processing is verified as ON or OFF in S100 (S104). When it is determined that the ON/OFF information on the spare processing is verified as ON, the data block concerned or the peripheral data block containing the data block concerned is specified as the spare processing object data block (S105). Then, a data application of the spare processing object data block, or a pointer indicating the spare processing object data block is stored. On the other hand, when it is determined that the ON/OFF information on the spare processing is verified as OFF, an error code is generated (S106). Those procedures are repeatedly carried out until the verification of reproducing for all the data blocks is completed (S107). Note that the error code generated in S106, for example, is used to present a user with the fact that a recording failure occurs.

When a data block as an object of the spare processing (hereinafter referred to as “a spare processing object data block” for short) is specified in a manner as described above, next, the spare processing is executed in accordance with a flow chart shown in FIG. 5.

The controller 120, firstly, determines whether the ON/OFF information on the spare processing is verified as ON or OFF (S110), and verifies whether or not the spare processing object data block is present (S111). When it is determined that the ON/OFF information on the spare processing is verified as ON, and also it is determined that the spare processing object data block is present, a new spare area for recording of the spare processing object data block is secured (S112). At this time, the spare area is secured by a preset storage capacity. However, a new spare area may be secured by a storage capacity equal to or larger than that in which the spare processing object data block can be recorded.

Next, it is verified whether or not the capacity of the secured spare area is sufficient to record therein the spare processing object data block (S113). When it is verified that the capacity of the secured spare area is not sufficient to record therein the spare processing object data block (NO in S114), an additional spare area is secured (S115). On the other hand, when it is verified that the capacity of the secured spare area is sufficient to record therein the spare processing object data block (YES in S114), the spare processing object data block is recorded in the secured spare area (S116), and the spare processing information or the defect management list information is recorded (S117) to complete the first reproducing processing.

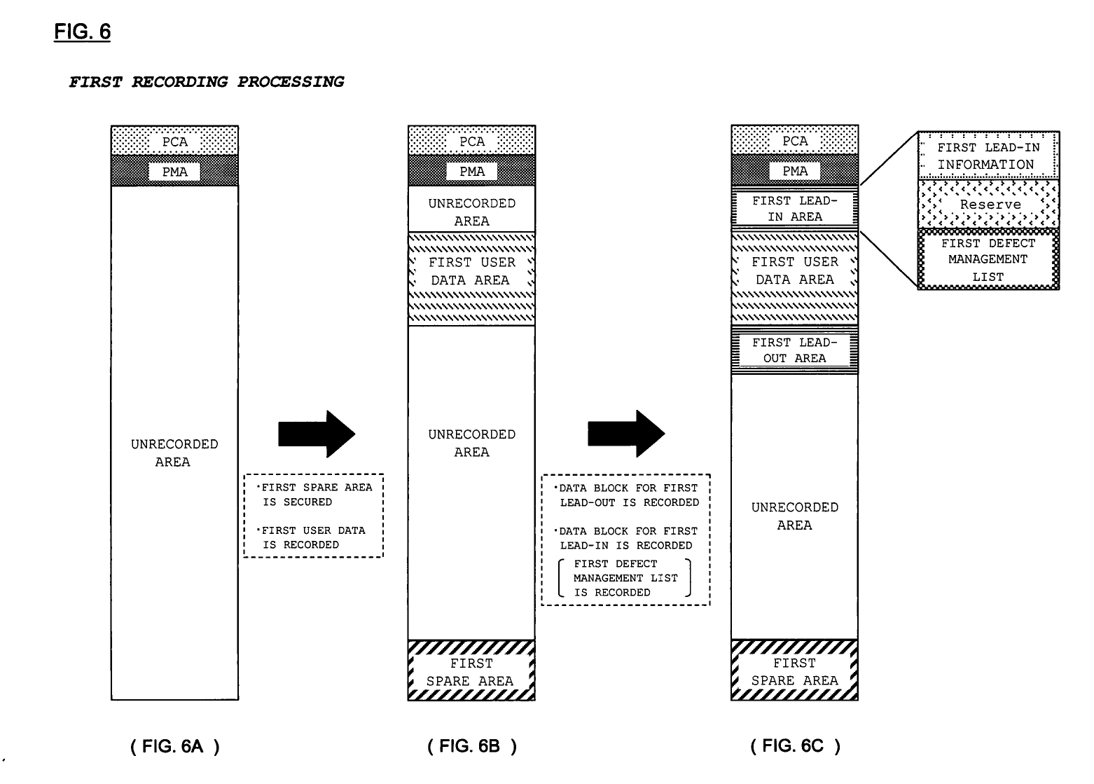

FIGS. 6A to 6C are diagrams showing an example of data mapping on the write once type disc when the first recording processing described in FIGS. 4 and 5 is executed. As shown in FIG. 6A, the PCA and PMA are provided in an inner periphery of the disc. When no data is recorded in the write once type disc, the first recording processing is executed since the spare processing information or the defect management list information is not stored. A description will hereinafter be given with respect to the mapping where the ON/OFF information on the spare processing is verified as ON.

When the first recording processing is started to be executed, first of all, after an area for recording of a data block for first lead-in is secured in an unrecorded area, first user data is recorded from a position next thereto. When as described above, it is detected in verification for reproducing of the recording data that the reproducing is impossible, or that the amount of error in the reproduced data block exceeds the predetermined amount of error, as shown in FIG. 6B, a first spare area is secured in an outer periphery of the write once type disc. Then, the processing for recording the first user data is completed while the spare processing object data block is recorded in the first spare area.

Thereafter, when the finalizing processing is executed, as shown in FIG. 6C, information containing the first lead-in information and first defect management list information is recorded in the first lead-in area. Moreover, a first lead-out area is secured next to a position of end of recording of the first user data, and first lead-out information is recorded in the first lead-out area. Thus, the first lead-in information and the first lead-out information are recorded to thereby complete the finalizing processing. Note that the defect management list information has to be contained in at least one of the lead-in information and the lead-out information. In addition, the lead-in information and the lead-out information may be recorded in no particular order.

<Second Recording Processing>

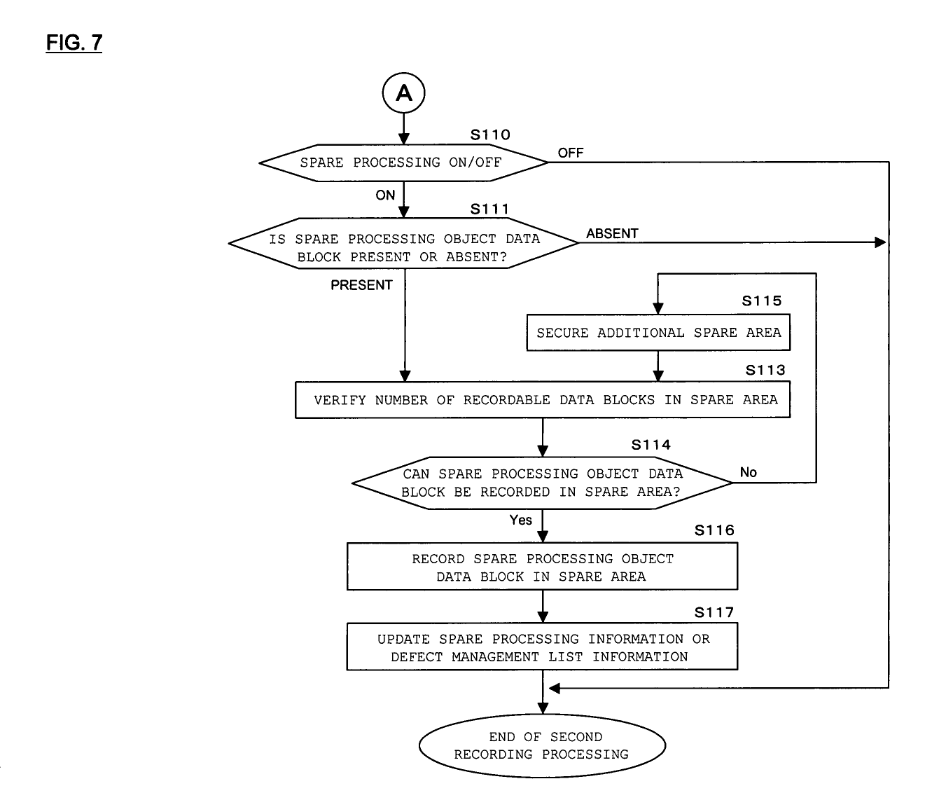

An operation in the second recording processing (S16) shown in FIG. 3 will hereinafter be described with reference to FIG. 7. Note that since the operational flow up to the processing for specifying a spare processing object data block of the second recording processing is the same as that of the processing shown in FIG. 4. Only the spare processing after specifying the spare processing object block is shown in FIG. 7. In addition, of steps in FIG. 7, the same steps as those in FIG. 5 are denoted with the same reference numerals.

Note that in the second recording processing as well, similarly to the above-mentioned first recording processing, it is supposed that the recording failure in the recording, and the data loss due to a disc defect occur, and thus the processing to verify whether or not the recording is proper is executed whenever a predetermined number of data blocks are recorded. When such verification is not carried out, the reproducing verification processing and the spare processing for the recorded data will be executed in the reproducing processing as will be described later.

In the second recording processing, the spare area for recording of the spare processing object data block is already secured in the former recording/reproducing processing. Hence, when it is judged that the ON/OFF information on the spare processing is verified as ON (S110), and also it is judged that the spare processing object data block is present (S111), it is verified whether or not a capacity of the spare area already secured is sufficient to record therein the spare processing object data block (S113 and S114). Then, when it is judged that the capacity of the spare area already secured is not sufficient, an additional spare area can be newly secured (S115). When the capacity of the spare area is sufficient, the spare processing object block is recorded in this spare area (S116). Further, the spare processing information or the defect management list is updated (S117). Thus, the second recording processing is completed.

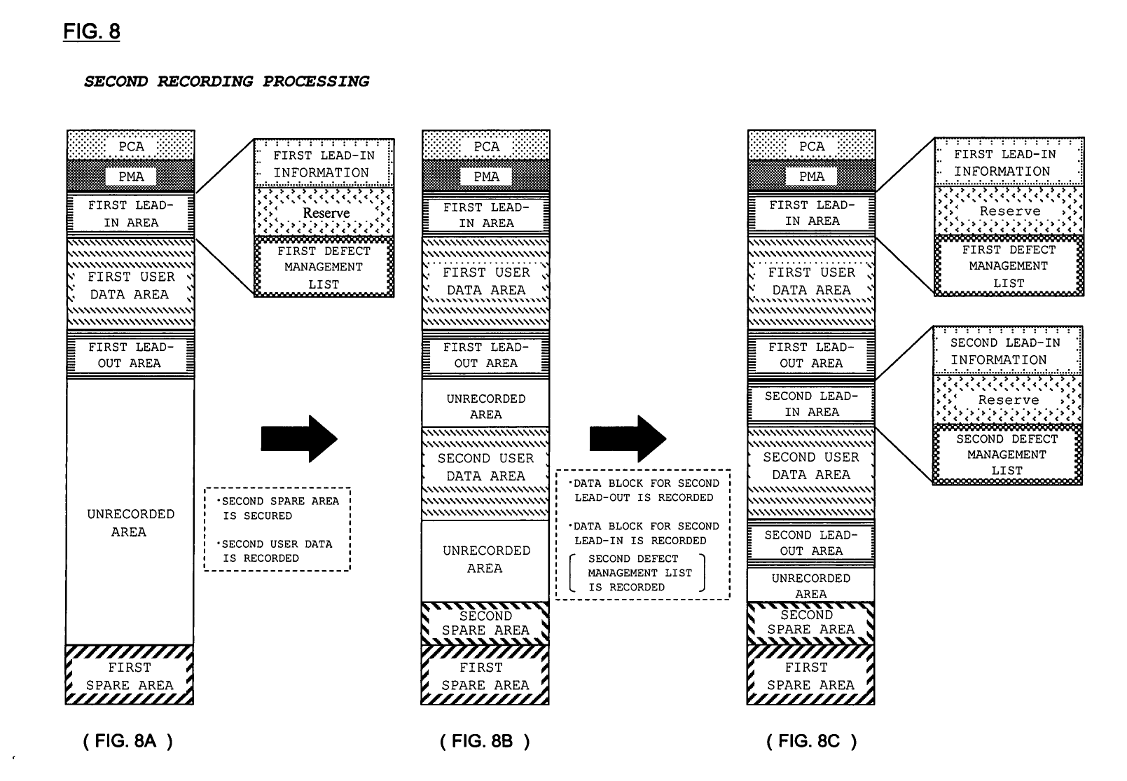

FIGS. 8A to 8C are diagrams showing an example of data mapping on the write once type disc when the second recording processing is executed. As shown in FIG. 8A, the PCA and PMA are provided in an inner periphery of the disc. Moreover, the first lead-in area, the first user data area, and the first lead-out area are already secured through the former recording/reproducing processing.

When the second user data is recorded in a multi-session in the write once type disc, the second recording processing is executed since the spare processing information or the defect management list information is already recorded. A description will hereinafter be given with respect to the data mapping where the ON/OFF information on the spare processing is verified as ON.

When the second recording processing is started to be executed, first of all, after an area for recording of a data block for second lead-in is secured in a position next to the first lead-out area, second user data is recorded from a position next thereto. When as described above, it is detected in verification for reproducing of the recording data that the reproducing is impossible, or that the amount of error in the reproduced data block exceeds the predetermined amount of error, as described above, it is verified whether or not a capacity of a first spare area is sufficient to record therein the spare processing object data block. When it is verified that the capacity of the first spare area is not sufficient to record therein the spare processing object data block, as shown in FIG. 8B, a second spare area is newly secured in an outer periphery of the write once type disc. Then, the processing for recording the second user data is completed while the spare processing object data block is recorded in the first or second spare area.

Thereafter, when the finalizing processing is executed, as shown in FIG. 8C, information containing the second lead-in information and second defect management list information is recorded in the second lead-in area. Moreover, a second lead-out area is secured next to a position of end of recording of the second user data, and second lead-out information is recorded in the second lead-out area. Thus, the second lead-in information and the second lead-out information are recorded to thereby complete the finalizing processing. Note that the defect management list information has to be contained in at least one of the lead-in information and the lead-out information. In addition, the lead-in information and the lead-out information may be recorded in no particular order.

<First Reproducing Processing>

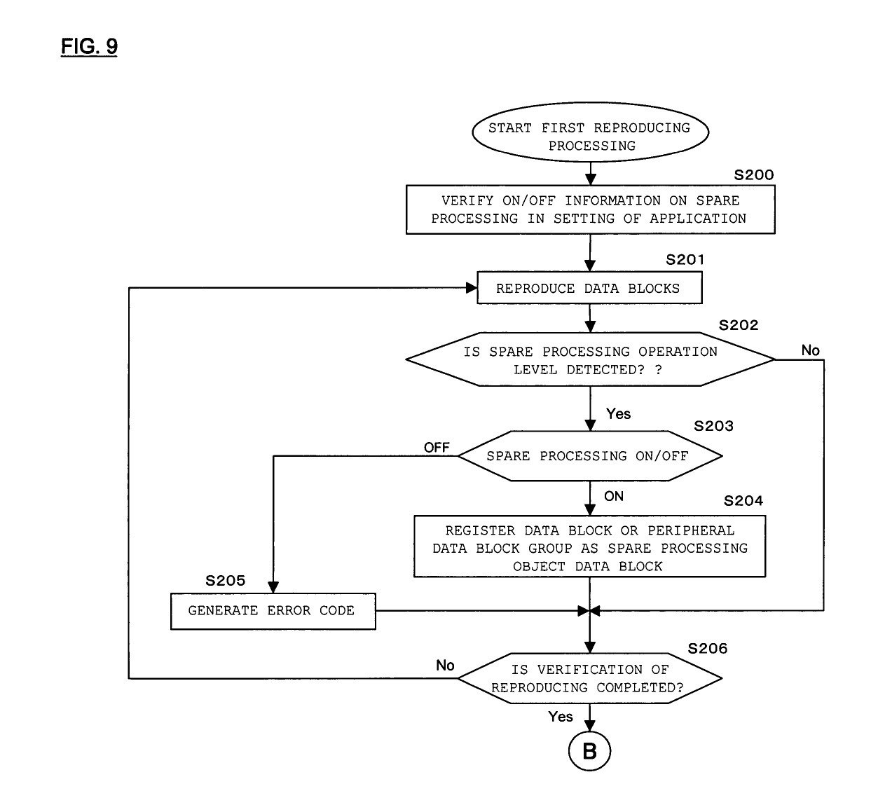

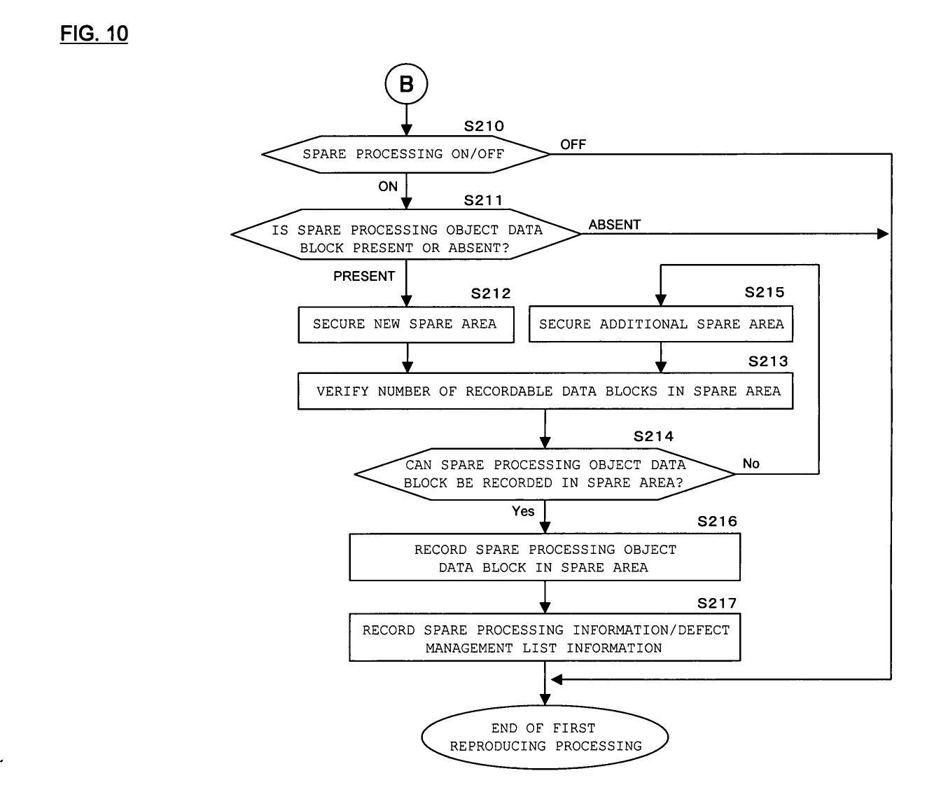

FIGS. 9 and 10 are flow charts each showing an operation in the first reproducing processing (S18) shown in FIG. 3. Note that as described above, the first reproducing processing is executed when the spare processing information or the defect management list information is not yet recorded in the write once type disc. In the first reproducing processing, not only the data reproducing, but also the spare processing for the recorded data are executed.

Referring to FIG. 9, when the first reproducing processing is started to be executed, first of all, the controller 120 verifies ON/OFF information on the spare processing in setting of an application for an upper application (S200). Next, the data blocks in the specified area are successively reproduced (S201) to output the reproduced data to the circuit in the subsequent stage. During such reproducing processing, it is simultaneously verified whether or not an amount of error in each data block exceeds a predetermined amount of error (S202). When it is verified that the amount of error in each data block exceeds the predetermined amount of error, the processing for registering a spare processing object data block, and the spare recording processing for the spare area are executed in accordance with ON/OFF of the spare processing information in S203.

Note that the processing for specifying the spare processing object data block in S203 to S206 is the same as that in S104 to S107 shown in FIG. 4.

That is to say, it is determined whether the ON/OFF information on the spare processing is verified as ON or OFF in S200 (S203). When it is determined that the ON/OFF information on the spare processing is verified as ON, the data block concerned or the peripheral data block containing the data block concerned is specified as the spare processing object data block (S204). Then, a data application of the spare processing object data block, or a pointer indicating the spare processing object data block is stored. On the other hand, when it is determined that the ON/OFF information on the spare processing is verified as OFF, an error code is generated (S205). Those procedures are repeatedly carried out until the verification of reproducing for all the specified data blocks is completed (S206). Note that the error code generated in S205, for example, is used to present a user with the fact that a recording failure occurs.

The spare recording processing in S210 to S217 of FIG. 10 is the same as that in S110 to S117 of FIG. 5.

That is to say, the controller 120, firstly, determines whether the ON/OFF information on the spare processing is verified as ON or OFF (S210), and verifies whether or not the spare processing object data block is present (S211). When it is determined that the ON/OFF information on the spare processing is verified as ON, and also it is determined that the spare processing object data block is present, a new spare area for recording of the spare processing object data block is secured (S212). At this time, the spare area is secured by a preset storage capacity. However, a new spare area may be secured by a storage capacity equal to or larger than that in which the spare processing object data block can be recorded. Next, it is verified whether or not the capacity of the secured spare area is sufficient to record therein the spare processing object data block (S213). When it is verified that the capacity of the secured spare area is not sufficient to record therein the spare processing object data block (NO in S214), an additional spare area is secured (S215). On the other hand, when it is verified that the capacity of the secured spare area is sufficient to record therein the spare processing object data block (YES in S214), the spare processing object data block is recorded in the secured spare area (S216), and the spare processing information or the defect management list information is recorded (S217) to complete the first reproducing processing.

Consequently, in the spare recording in the first reproducing processing, as shown in FIG. 6, when a defective data block is detected during the reproducing processing, the proper data (which is obtained by performing error-correction on the data of the defective data block) is spare-recorded in the first spare area.

It should be noted that in S202 of FIG. 9, even if an amount of error in each data block exceeds a predetermined amount of error, when an amount of error is so much that the error correction cannot be performed, the judgment results show “NO”. The judgment results are based on the fact that when the error correction is impossible, the data to be spare-recorded in the spare area cannot be obtained by the error correction. That is to say, in S216 of FIG. 10, there is executed the processing in which the data in the spare processing object data block is error-corrected to restore the proper data, and the resultant proper data is recorded in the spare area. However, since the proper data to be recorded in the spare area cannot be restored when the error correction is impossible, the spare recording cannot be carried out. As a result, in S202 of FIG. 9, even if the amount of error in each data block exceeds the predetermined amount of error, when the amount of error is so much that the error correction cannot be performed, this case is processed with no detection of the spare processing operation level.

<Second Reproducing Processing>

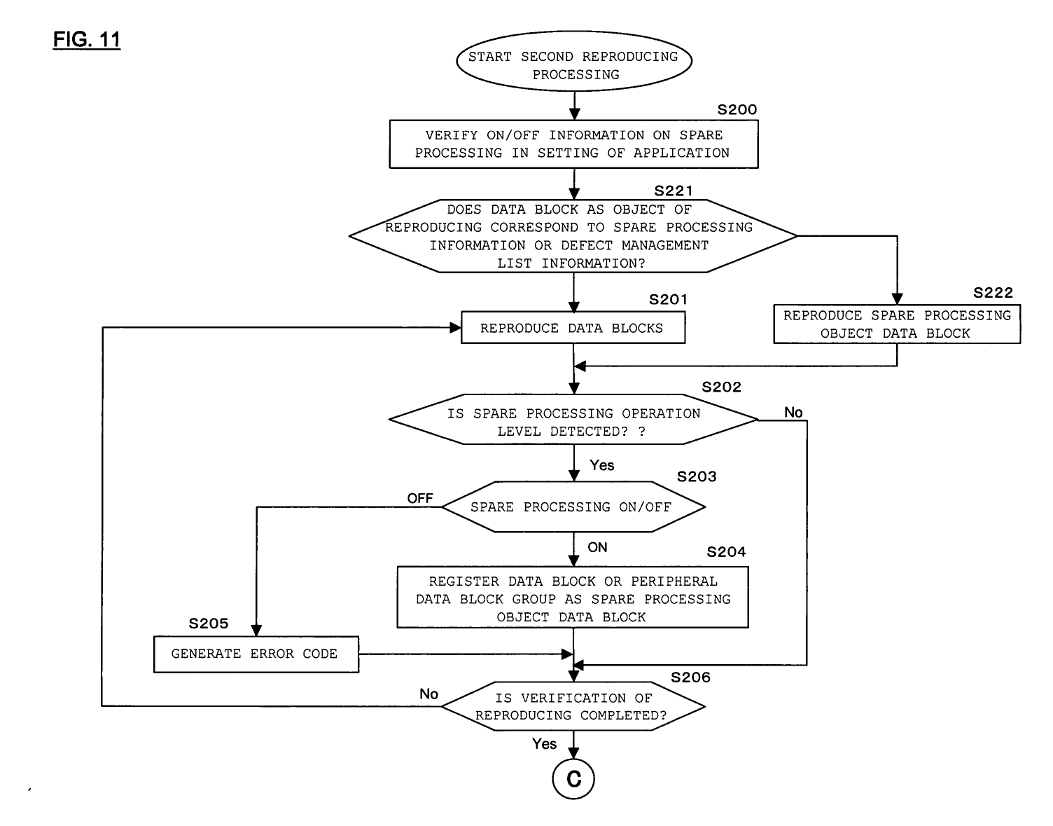

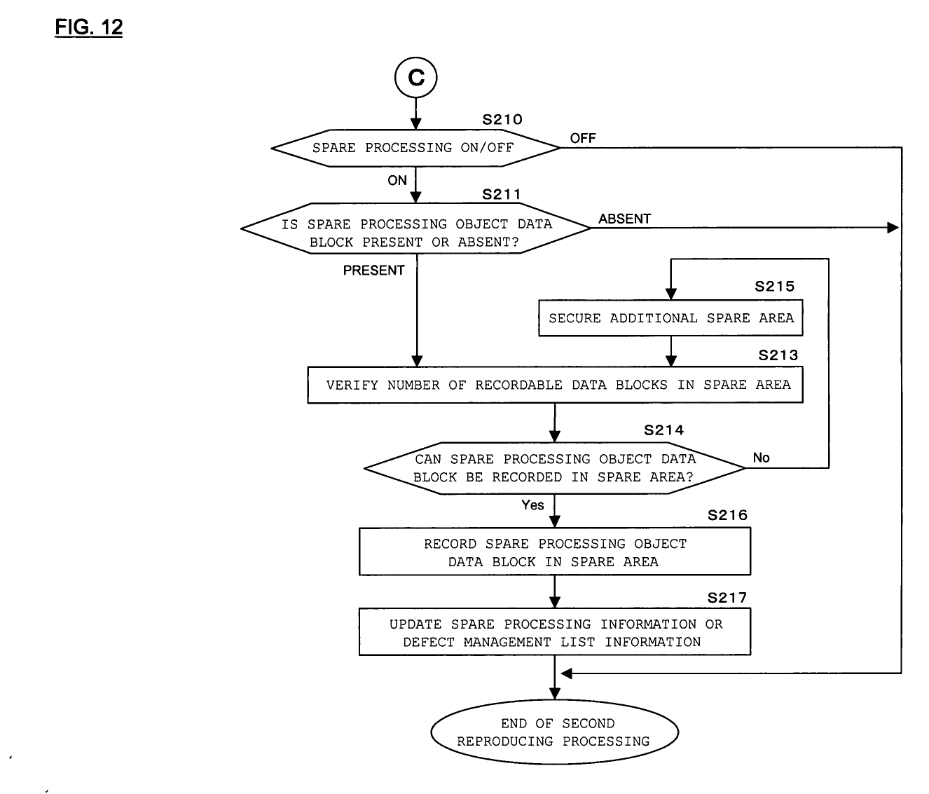

FIGS. 11 and 12 are flow charts each showing the operation of the second reproducing processing (S19) shown in FIG. 3.

Note that the second reproducing processing is executed when the spare processing information or the defect management list information is already recorded in the write once type disc. Thus, in the flow chart shown in FIG. 11, a step of determining whether or not the spare area is substituted for a data block as an object of reproducing (hereinafter referred to as “a reproducing object data block” for short) (S221), and a step of reproducing the data block in the corresponding spare area when the spare area is substituted for the reproducing object data block (S222) are added to the flow chart shown in FIG. 11 unlike the flow chart shown in FIG. 9. Other processing (S201 to S206) is the same as that shown in FIG. 9.

In addition, the spare recording processing in step 210 to S217 of FIG. 12 is the same as that in S110 to S117 of FIG. 7 shown in the above-mentioned second recording processing.

That is, when it is judged that the ON/OFF information on the spare processing is verified as ON in S210, and also it is judged that the spare processing object data block is present in S211, it is verified whether or not a capacity of the spare area is sufficient to record therein the spare processing object data block (S213 and S214). Then, when it is judged that the capacity of the spare area is not sufficient to record therein the spare processing object data block, an additional spare area is newly secured (S215). On the other hand, when it is judged that the capacity of the spare area is sufficient to record therein the spare processing object data block, the spare processing object data block is recorded in the spare area (S216). Moreover, the spare processing information or the defect management list information is updated (S217). As a result, the second reproducing processing is completed.

Consequently, in the spare recording in the second reproducing processing, similarly to the second recording processing shown in FIG. 8, when a defective data block is detected during the reproducing processing, the proper data (which is obtained by performing error-correction on the data of the defective data block) is spare-recorded in the first spare area. When the first spare area is insufficient in capacity, a second spare area is newly secured. Then, the proper data which is substituted for the data of the defective data block is spare-recorded in the first and second spare areas.

As described above, according to this embodiment, when the ON/OFF information on the spare processing is set as OFF, the data mapping on the write once type disc can be made to perfectly agree with the data mapping on the reproducing dedicated type disc. Thus, it is possible to firmly maintain the interchangeability, between both the discs, including the capacity interchangeability.

On the other hand, when the ON/OFF information on the spare processing is set as ON, the spare area can be secured in the position not impeding the data mapping similar to the data mapping on the reproducing dedicated type disc to carry out the spare recording of the defective data block while the data mapping concerned is maintained. Consequently, the defective reproducing can be avoided while the interchangeability with the reproducing dedicated type disc is maintained.

Note that since a spare area is newly set when the ON/OFF information on the spare processing is set as ON in such a manner, in the strict sense of the word, it is impossible to maintain the capacity interchangeability with the reproducing dedicated type disc. However, in the case of the write once type disc, it is rare that all unrecorded areas are used for the recording of the user data up. Hence, in the normal utilization form, some idle capacity remains. Consequently, even if a supposed remaining capacity is utilized as the spare area, no inconvenience for a user occurs. If anything, a case where as described above, a spare area is secured to carry out the spare recording in response to the user's requests contributes to the convenience for a user.

As described above, according to this embodiment, it is possible to realize the information recording and reproducing device which is capable of enhancing the convenience for a user while maintaining the interchangeability with the reproducing dedicated type disc.

### B. Second Embodiment

A second embodiment which is obtained by improving the first embodiment will hereinafter be described.

The second embodiment is such that it is determined based on a storage capacity (storable capacity) remaining in the disc and a capacity (storage data capacity) of data to be stored in the disc whether or not a spare area can be secured, and when it is determined that the spare area can be secured, data is spare-recorded in the spare area.

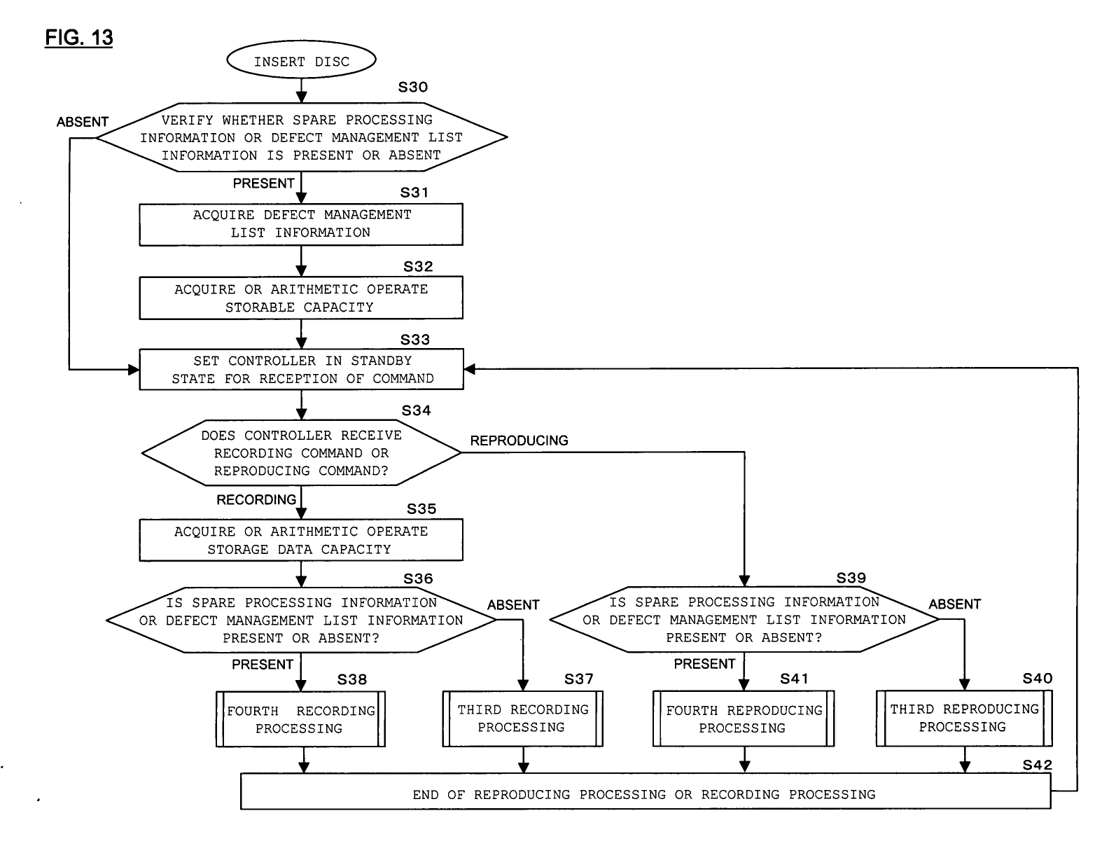

FIG. 13 shows a flow chart during the recording/reproducing operation of the information recording and reproducing device in the second embodiment.

When the write once type disc is inserted into the information recording and reproducing device, first of all, there is verified the presence or absence of the spare processing information containing the presence or absence of a spare and information on a spare, or the presence or absence of the defect management list information having a relationship between a spare source and a spare destination recorded therein (S30). In this embodiment, when it is verified that there is a spare, the defect management list information is recorded in an area different from the lead-in area. Thus, it is verified in S30 whether or not the defect management list information is recorded in this area. When it is verified in S30 that the defect management list information is recorded in this area, the defect management list information is acquired in S31. Moreover, the storable capacity (idle capacity) of the disc is determined (S32). Note that information for determining of the storable capacity is recorded in the PMA area of the disc. Then, the operation state of the controller 120 becomes a standby state of reception of a command (S33).

Thereafter, when the controller 120 receives the recording command (S34), a storage capacity of data to be stored in the disc is calculated (S35). Next, either third recording processing (S37) or fourth recording processing (S38) is executed in accordance with the presence or absence of the spare processing information or the defect management list information (S36). The details of the processing will be described later. Then, when the recording processing is completed, the controller 120 is informed of completion of the recording processing (S42).

On the other hand, when the controller 120 receives the reproducing command (S34), either third reproducing processing (S40) or fourth reproducing processing (S41) is executed in accordance with the presence or absence of the spare processing information or the defect management list information (S39). The details of the processing will be described later. Then, when the reproducing processing is completed, the controller 120 is informed of completion of the reproducing processing (S42). Thereafter, the recordable capacity is calculated again (S32), and the operation state of the controller 120 becomes the standby state of reception of a command (S33).

<Third Recording Processing>

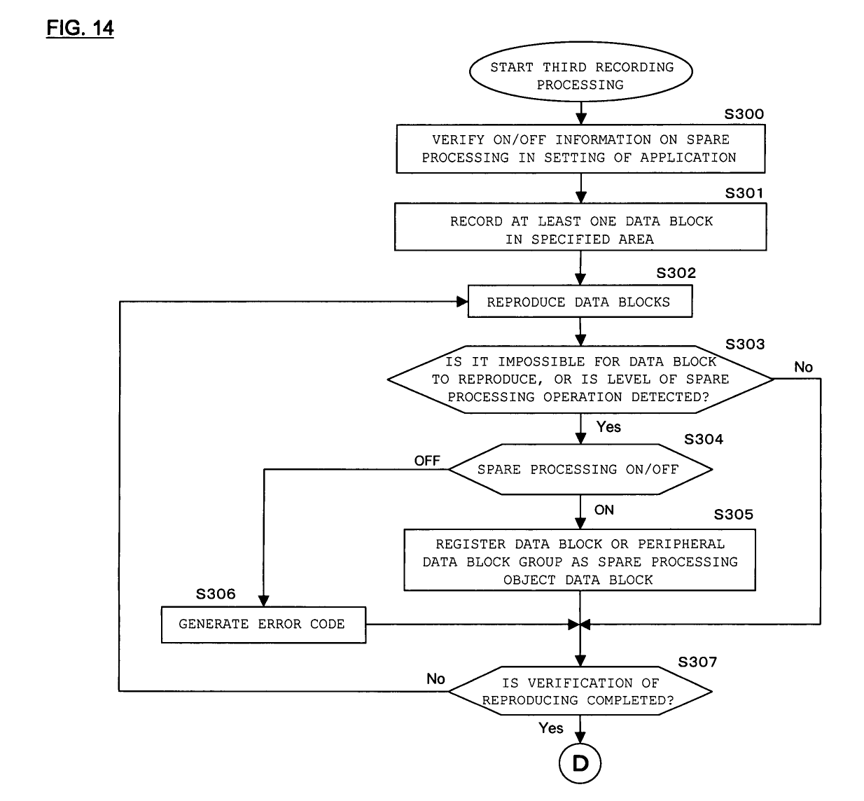

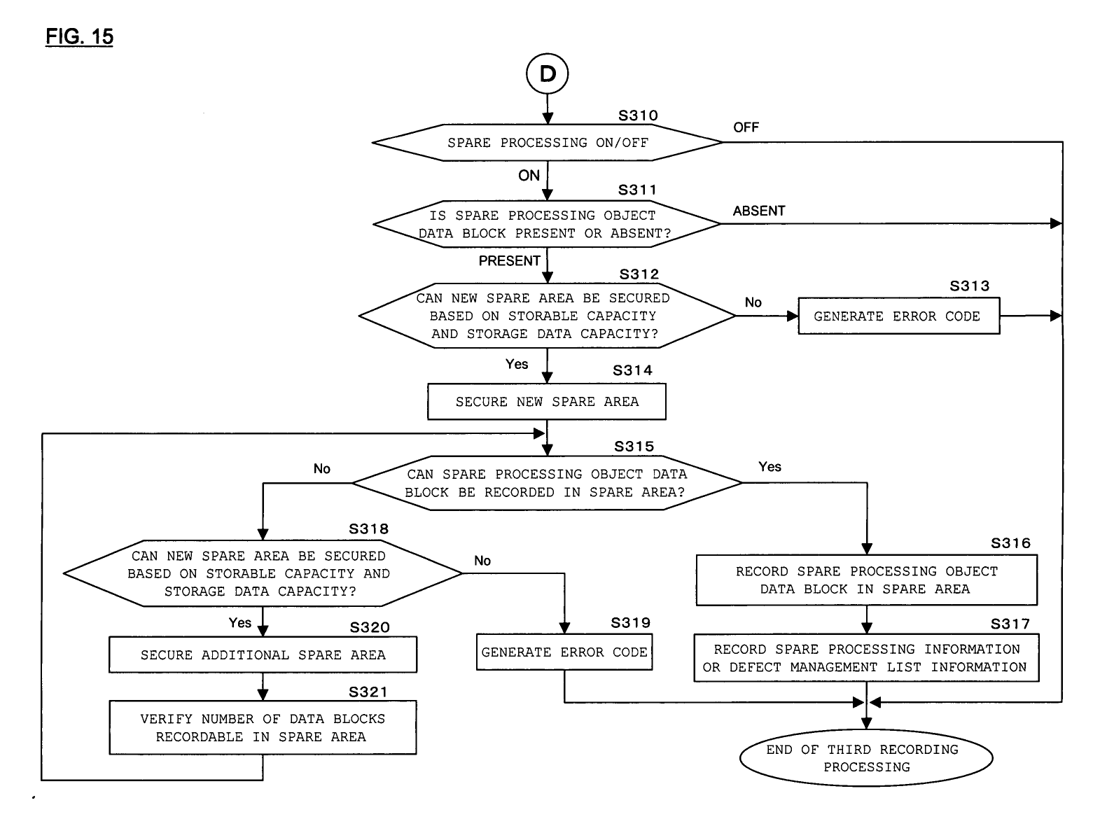

FIGS. 14 and 15 are flow charts each showing an operation of third recording processing (S37) show in FIG. 13. In this processing, similarly to the above-mentioned first embodiment, it is supposed that the recording failure in the recording processing, and the data loss due a disc defect occur. Thus, in the third recording, the processing to verify whether or not the recording is proper is executed whenever a predetermined number of data blocks are recorded. When such verification is not carried out, the reproducing verification processing and the spare processing for the recording data will be executed in the reproducing processing as will be described later.

Note that in the flow charts shown in FIGS. 14 and 15, the processing in S300 to S307 of FIG. 14 is the same as that in S100 to S107 (refer to FIG. 4) of the first recording processing in the first embodiment. Consequently, since the processing for specifying a spare processing object data block is the same as the first recording processing shown in the above-mentioned first embodiment, its description is omitted here.

When a spare processing object data block is specified in accordance with the processing flow shown in FIG. 14, next, the spare processing is executed in accordance with a flow chart shown in FIG. 15.

First of all, the controller 120 judges whether or not the ON/OFF information on the spare processing is verified as ON (S310), and judges whether or not the spare processing object data block is present (S311). When it is judged that the ON/OFF information on the spare processing is verified as ON, and also it is judged that the spare processing object data block is present, it is determined based on the recordable capacity and the recording data capacity whether or not a new spare area can be secured (S312). Then, when it is judged in S312 that no new spare area can be secured, an error code is generated (S313) to complete the third recording processing. On the other hand, when it is judged in S312 that the new spare area can be secured, the new spare area for recording of the spare processing object data block is secured (S314). At this time, the spare area is secured by a present storage capacity. However, a spare area having a storage capacity equal to or larger than that in which the spare processing object data block can be recorded may also be secured.

Next, it is verified whether or not the storage capacity of the spare area is sufficient to record therein the spare processing object data block (S315). When it is judged in S315 that the storage capacity of the spare area is not sufficient, it is judged based on the recordable capacity and the recording data capacity whether or not an additional spare area can be secured (S318). Here, when it is judged in S318 that no additional spare area can be secured, an error code is generated (S319) to complete the third recording processing. On the other hand, when it is judged in S318 that the additional spare area can be secured, this additional spare area is secured (S320). When the capacity of the spare area becomes sufficient to record therein the spare processing object data block by this additional spare area (S321 and S315), the spare processing object data block is recorded in the spare area (S316). Then, the spare processing information or the defect management list information is recorded in the spare area (S317) to complete the third recording processing.

When although the additional spare area is secured in S320, it is judged that the capacity of the spare area is not yet sufficient, the operation is returned back to the processing S315 to S318, and the processing for addition of a spare area is executed again. Then, it is judged that the capacity of the spare area becomes sufficient by further adding the spare area, the spare processing object data block is recorded in the spare area (S316). Then, the spare processing information or the defect management list information is recorded in the spare area (S317). On the other hand, when no additional spare area can be secured (NO in S318), an error code is generated (S319) to complete the third recording processing.

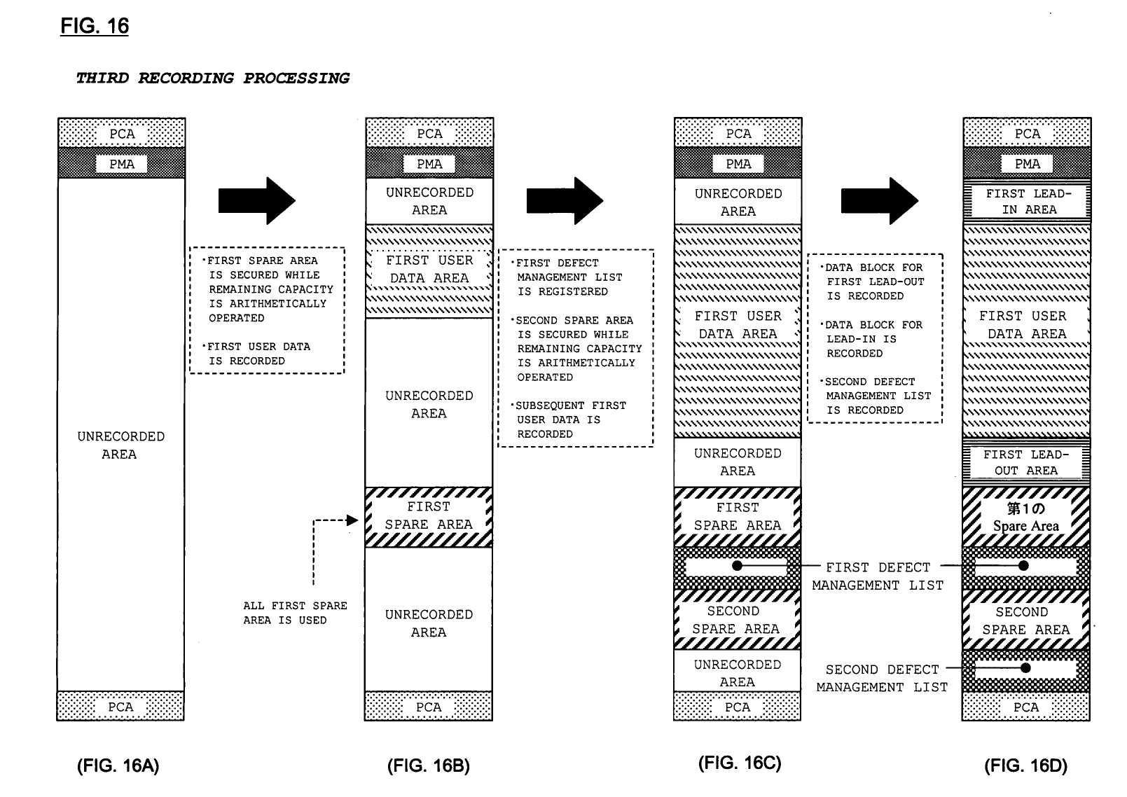

FIGS. 16A to 16D are diagrams showing an example of data mapping on the write once type disc when the above-mentioned third recording processing is executed. As shown in FIG. 16A, the PCAs are provided in an inner periphery and an outer periphery of the disc, respectively, and the PMA is provided in the inner periphery of the disc. Since when the write once type disc is in an unrecorded state, the spare processing information or the defect management list information is not yet recorded, the third recording processing is executed. A description will hereinafter be given with respect to the case where the ON/OFF information on the spare processing is verified as ON.

When the first recording processing is started to be executed, first of all, after an area for recording of a data block for the first lead-in in an unrecorded area is secured, the first user data is recorded from a position next thereto. As described above, when it is detected that the reproducing processing is impossible or an amount of error in the reproduced data block exceeds a predetermined amount of error in verification of reproducing of the recording data, it is determined based on the recordable capacity and the recording data capacity whether or not the first spare area and the first defect management information area can be secured. When it is judged that the first spare area and the first defect management information area can be secured, as shown in FIG. 16B, a position where the data block for the first lead-out area is to be recorded is obtained through the arithmetic operation to secure the first spare area in the outer peripheral position of the first lead-out area. Then, the recording of the first user data continues while the spare processing object data block is recorded in the first spare area.

Moreover, as shown in FIG. 16C, in a case where the first spare area is used up when the first user data is recorded, or in a case where an amount of recordable data block remaining in the first spare area is less than an amount of spare processing object data block intended to be recorded, the first defect management list information on the first spare area is continuously recorded in the first spare area. Then, it is determined based on the recordable capacity and the recording data capacity whether or not a second spare area and a second defect management list information area can be secured as an additional spare area. When it is judged that the second spare area and the second defect management information area can be secured, the second spare area is secured next to the first management list information area.

Thereafter, the recording of the first user data continues while the data of the spare processing object data block is recorded in the second spare area. Then, after completion of the recording of the first user data, the second defect management list information on the second spare area is recorded in the position next to the second spare area.

Thereafter, when the finalizing processing is executed, as shown in FIG. 16D, the data block for the first lead-out and the data block for the first lead-in are recorded to complete the finalizing processing. Note that the first spare area, the first defect management list information, the second spare area, and the second defect management list information can be recorded or secured in arbitrary positions, respectively, as long as those arbitrary positions are located on an outer peripheral side of the first lead-out area. In addition, the recording of the data may be carried out in no particular order.

<Fourth Recording Processing>

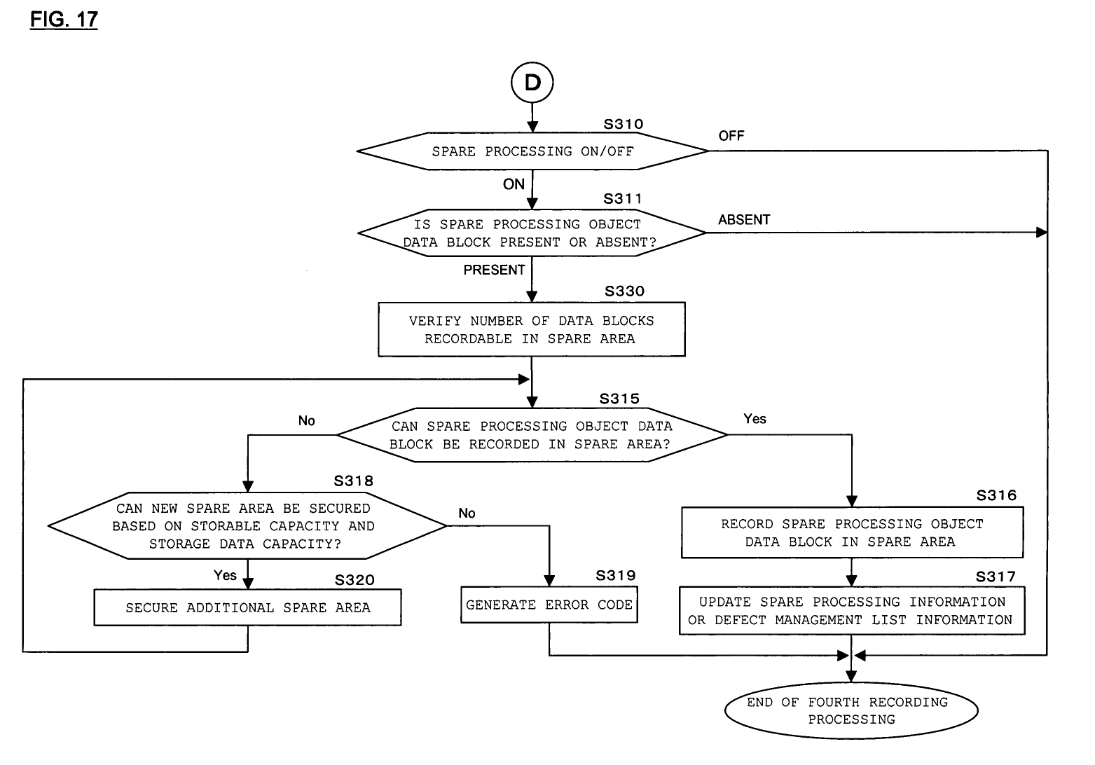

An operation in the fourth recording processing (S38) shown in FIG. 13 will hereinafter be described with reference to FIG. 17. Note that since the operational flow up to the processing for specifying a spare processing object data block of the fourth recording processing is the same as that of the processing shown in FIG. 14, its illustration is omitted, and hence only the spare processing is shown in FIG. 17. In addition, of steps in FIG. 17, the same steps as those in FIG. 15 are denoted with the same reference numerals.

Note that in the fourth recording processing as well, similarly to the above-mentioned third recording processing, it is supposed that the recording failure in the recording, and the data loss due to a disc defect occur, and thus the processing to verify whether or not the recording is proper is executed whenever a predetermined number of data blocks are recorded. When such verification is not carried out, the reproducing verification processing and the spare processing for the recorded data will be executed in the reproducing processing as will be described later.

In the fourth recording processing, the spare area for recording of the spare processing object data block is already secured in the former recording/reproducing processing. Hence, when it is judged that the ON/OFF information on the spare processing is verified as ON (S310), and also it is judged that the spare processing object data block is present (S311), it is verified whether or not a capacity of the spare area already secured is sufficient to record therein the spare processing object data block (S330 and S315). Then, when it is judged that the capacity of the spare area already secured is not sufficient, it is determined based on the storable capacity and the storage data capacity whether or not a new spare area can be secured (S318). When it is determined based on the storable capacity and the storage data capacity that the new spare area can be secured, an additional spare area is newly secured (S320). On the other hand, when it is determined that no new spare area can be secured, an error code is generated (S318) to complete the fourth recording processing.

When it is verified in S315 that the capacity of the spare area already secured is sufficient, the spare processing object data block is recorded in this spare area (S316). Then, the spare processing information or the defect management list information is updated (S317) to complete the fourth recording processing.

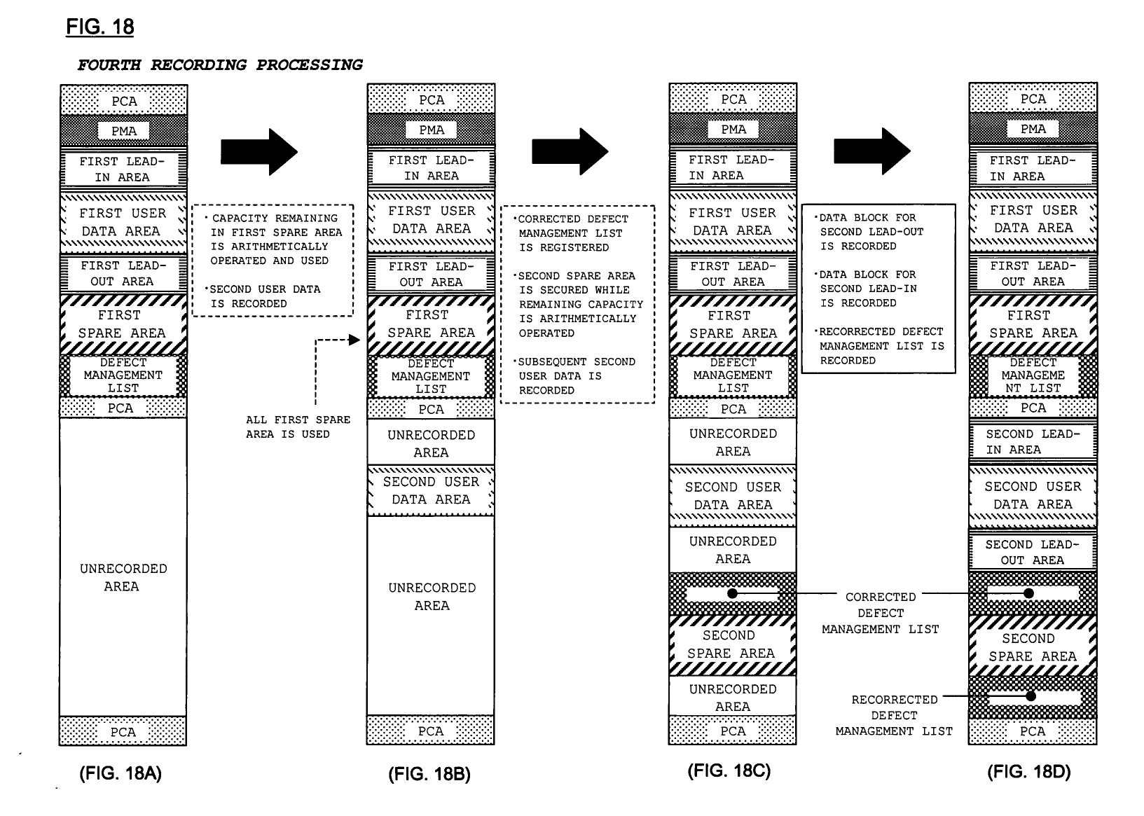

FIGS. 18A to 18D are diagrams showing an example of data mapping on the write once type disc when the fourth recording processing is executed. As shown in FIG. 18A, the PCAs are provided in an inner periphery and an outer periphery of the disc, respectively, and the PMA is provided in the inner periphery of the disc. Moreover, the first lead-in area, the first user data area, the first lead-out area, the first spare area, and the defect management list information area are already secured through the former recording/reproducing processing. Also, the PCA as an addition is secured in the outer periphery of the defect management list information area. When the second user data is recorded in a multi-session in the write once type disc, the fourth recording processing is executed since the spare processing information or the defect management list information is already stored. A description will hereinafter be given with respect to the case where the ON/OFF information on the spare processing is verified as ON.

When it is detected that the second user data is recorded in an unrecorded area, and the reproducing processing is impossible or an amount of error in the reproduced data block exceeds a predetermined amount of error in verifying reproducing of the recording data, the recordable capacity of the first spare area is arithmetically operated. When the recordable capacity of the first spare area is larger than the recording capacity for the spare processing object data block which is intended to be recorded, as shown in FIG. 18B, the recording of the second user data continues while the spare processing object data block is recorded in an idle capacity of the first spare area.

When the first spare area is used up during such recording processing, or when the recordable capacity of the first spare area becomes smaller than the recording capacity for the spare processing object data block which is intended to be recorded, a position where the data block in the second lead-out area is to be recorded is arithmetically operated, as shown in FIG. 8C. Then, corrected defect management list information is recorded in the outer peripheral position of the second lead-out area. Here, the corrected defect management list information is obtained by adding the defect management list information on the data which is spare-recorded in an idle area of the first spare area in recording the second user data to the defect management list information in the outer peripheral position of the first spare area.

Thereafter, the controller 120 determines based on the recordable capacity and the recording data capacity, whether or not the second spare area and the recorrected defect management list information area can be secured as an additional spare area. When it is determined that the second spare area and the recorrected defect management list information area can be secured as the additional spare area, the second spare area is secured next to the corrected defect management list information area. Then, the recording of the second user data continues while the spare processing object data block is recorded in the second spare area. Thereafter, after completion of the recording of the second user data, the recorrected defect management list information is recorded in the position next to the second spare area. Here, there corrected defect management list information is obtained by adding the defect management list information on the data which is spare-recorded in the second spare area to the above-mentioned corrected defect management list information.

Thereafter, when the finalizing processing is executed, data block for second lead-out and data block for second lead-in are recorded to complete the finalizing processing, as shown in FIG. 18D. Note that the second spare area, the corrected defect management list information and the recorrected defect management list information can be recorded or secured in arbitrary positions, respectively, as long as the arbitrary positions are located outside the user data area. In addition, the recording of data may be carried out in no particular order.

<Third Reproducing Processing>

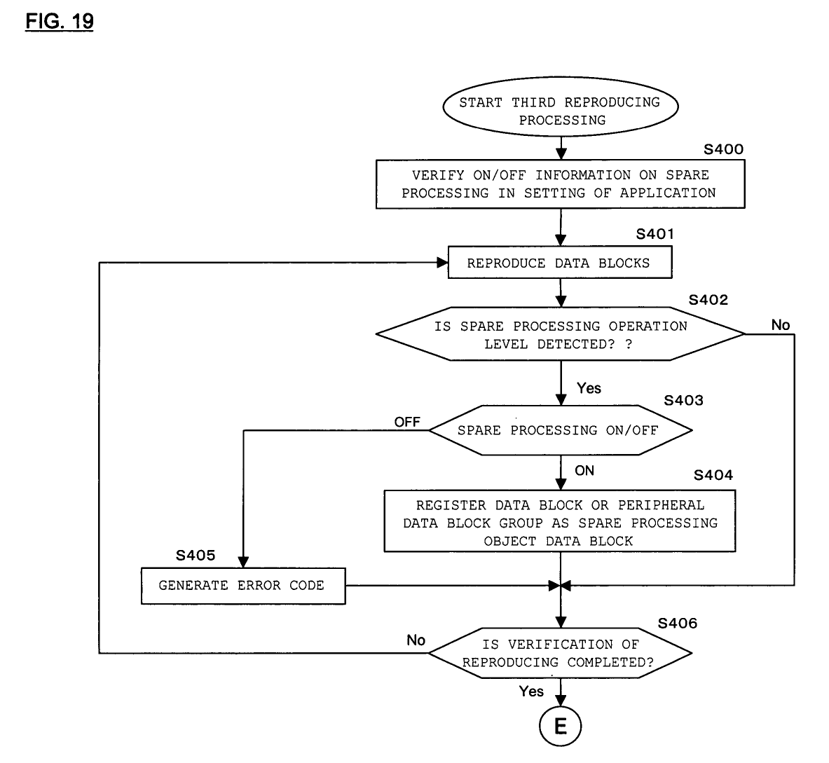

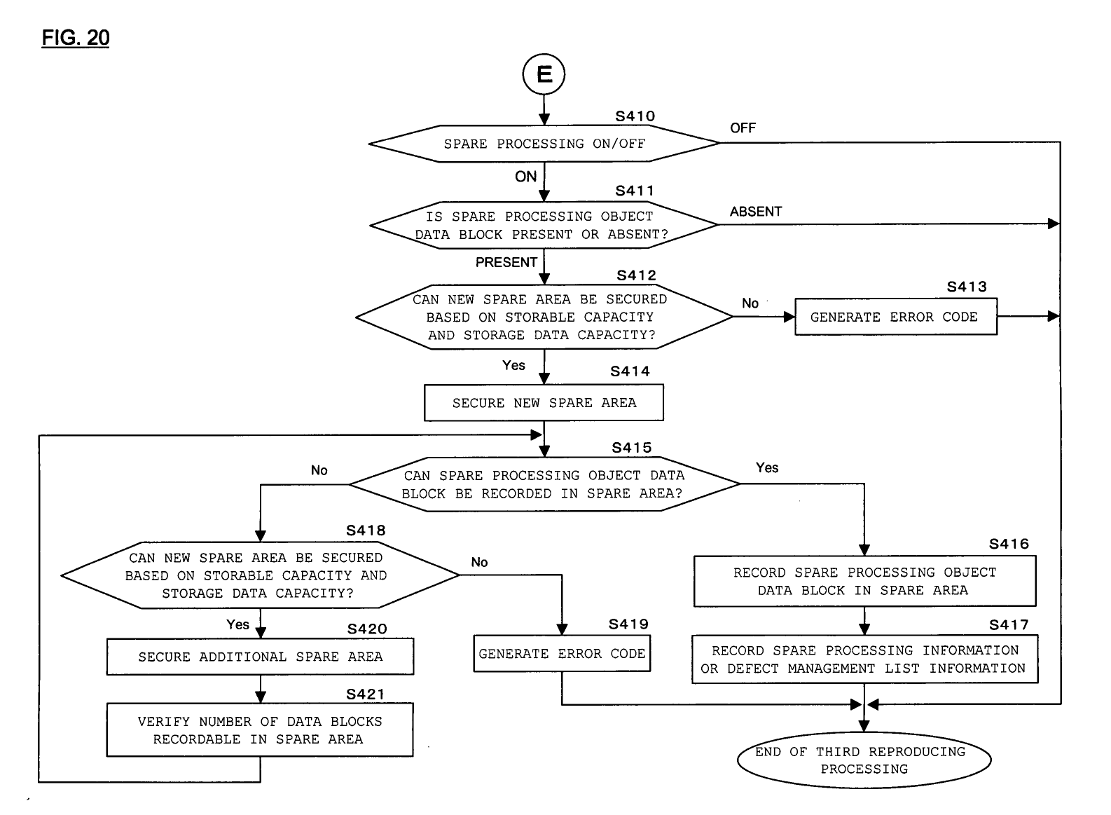

FIGS. 19 and 20 are flow charts each showing an operation in the third reproducing processing (S40) shown in FIG. 13. Note that processing steps (S400 to S406) shown in FIG. 19 are the same as those (S200 to S206) of FIG. 9 in the above-mentioned first embodiment, respectively. Thus, in the third reproducing processing, similarly to the first reproducing processing in the above-mentioned first embodiment, the reproducing processing and the processing for specifying the spare processing object data block are executed.

In addition, processing steps (S410 to S421) shown in FIG. 20 are the same as those (S310 to S321) shown in FIG. 15 in the above-mentioned third recording processing, respectively. However, in S416, the data which is obtained by performing error-correction on the data in the spare processing object data block is recorded in the spare area.

Consequently, in the third reproducing processing, similarly to the above-mentioned third processing, the processing for spare-recording the spare processing object data block in the spare area is executed. Thus, in the third reproducing processing, when the defective data block is detected during the reproducing processing, similarly to the processing shown in FIG. 16, the first spare area is secured, and the proper data which is obtained by performing error-correction on the data of the spare processing object data block is spare-recorded in the first spare area. Then, the defect management list information (first defect management list information) on the first spare area is recorded. Moreover, when the capacity of the first spare area becomes insufficient, the second spare area is newly secured, and the proper data and the defect management list information (second defect management list information) on the second spare area are recorded in the second spare area, respectively.

<Fourth Reproducing Processing>

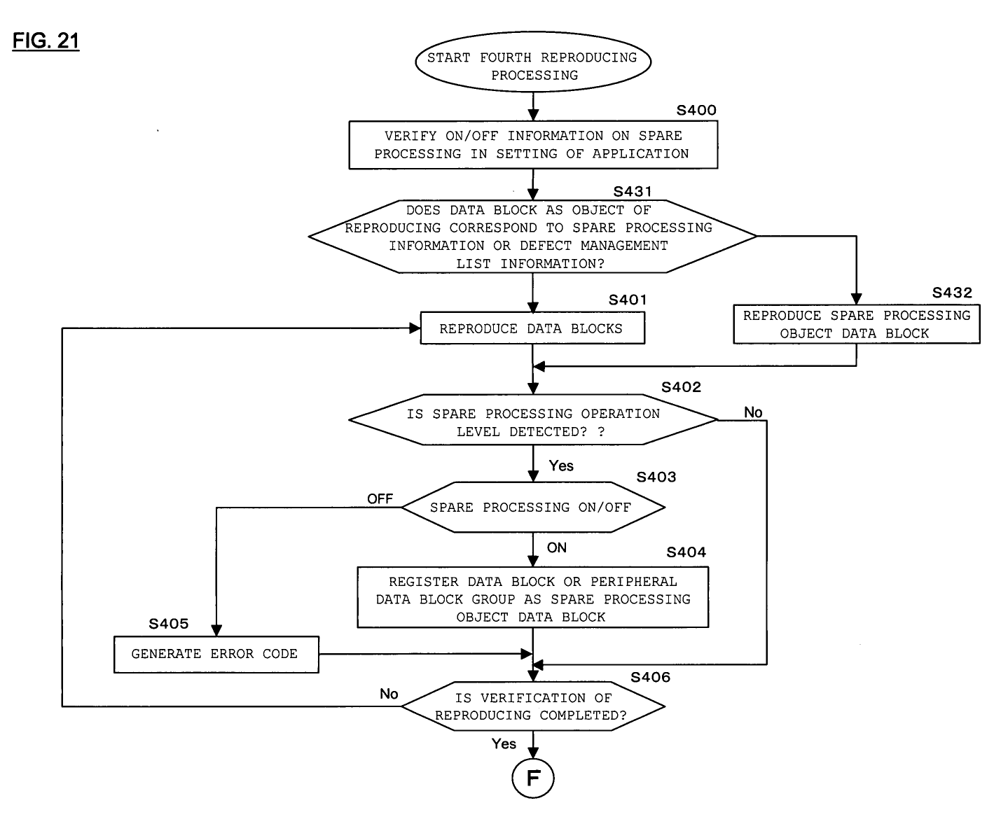

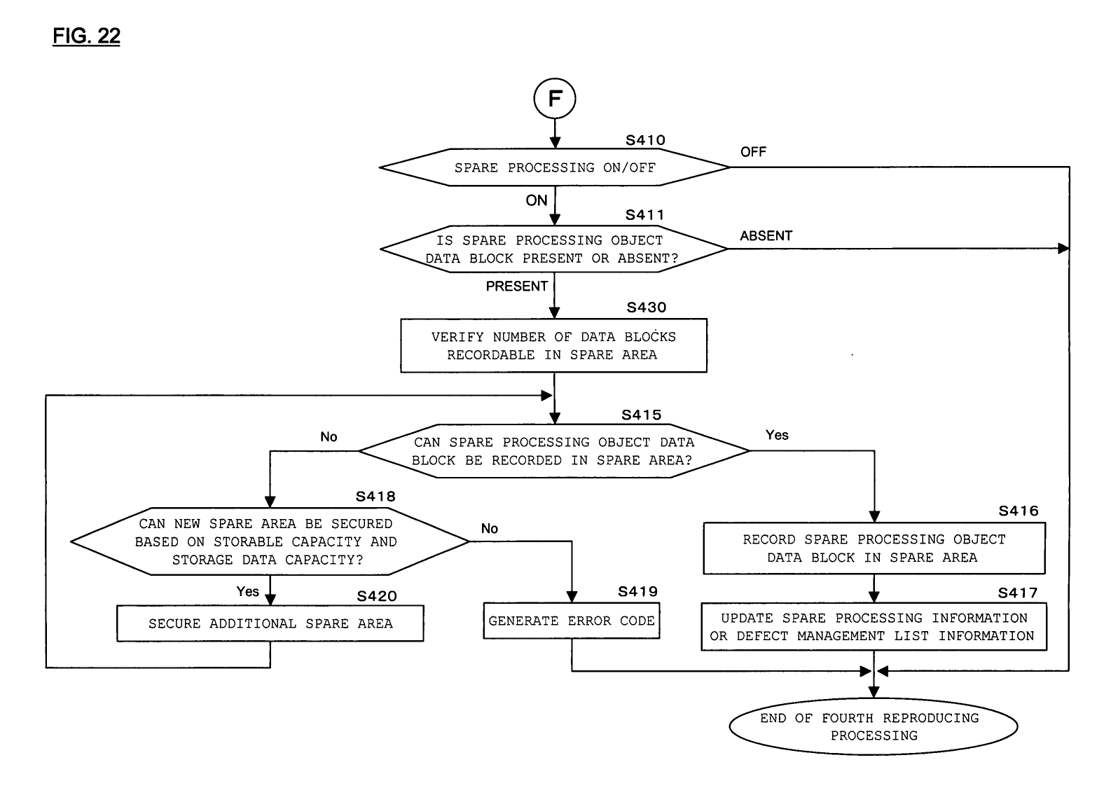

FIGS. 21 and 22 are flow charts each showing the operation of the fourth reproducing processing (S41) shown in FIG. 13.

Note that the fourth reproducing processing is executed when the spare processing information or the defect management list information is already recorded in the write once type disc. Thus, in the flow chart shown in FIG. 21, a step of determining whether or not the spare area is substituted for a reproducing object data block (S431), and a step of, when the spare area is substituted for the reproducing object data block, reproducing the data block in the corresponding spare area (S432) are added to the flow chart shown in FIG. 21 unlike the flow chart shown in FIG. 19. Other processing (S401 to S406) is the same as that shown in FIG. 19.

In addition, processing steps shown in FIG. 22 are the same as those of FIG. 17 described in the above-mentioned fourth recording processing. Consequently, in the fourth reproducing processing, similarly to the processing shown in FIG. 18, when the defective data block is detected during the reproducing processing, the proper data which is obtained by performing error-correction on the data of the defect data block is spare-recorded in the first spare area. When the capacity of the first spare area is not sufficient to record therein the proper data, the second spare area is newly secured, and thus the proper data for the defective data block is spare-recorded in the first and second spare areas. During this spare-recording, the corrected defect management list information and the recorrected defect management list information are recorded, similarly to the fourth recording processing shown in FIG. 18.

As described above, according to the second embodiment, it is determined whether or not the spare area can be secured based on the storage capacity (storable capacity) remaining in the disc and the capacity (storage data capacity) of the data to be stored in the disc. When it is determined that the spare are a can be secured, the data is spare-recorded in the spare area. As a result, in addition to the effects obtained in the first embodiment, it is further possible to realize the more efficient and smooth securing of the spare area.

It is to be understood that the present invention is not intended to be limited to the above-mentioned embodiment mode, and hence various changes may be made.

For example, in the above-mentioned processing steps shown in FIGS. 7, and 8A to 8C, when the spare processing object data block occurs in recording the second user data, the data block is initially spare-recorded in the first spare area. Then, after the first spare area is used up, the second spare area is secured, and the subsequent spare processing object data block is spare-recorded in the second spare area. However, there may be adopted such processing that when the second user data is recorded, the second spare area is secured in correspondence to occurrence of the spare processing object data block, and the spare processing object data block about the second user data is spare-recorded in the second spare area. In other words, when the data is recorded in a multi-session, the spare area may be secured at every session.

In this case, an idle area occurs in the spare area of each session. However, the spare processing object data block which occurred during the reproduction of the data block of each session can be recorded in the spare area of each session. Hence, the management for recording of the spare processing object data block can be smoothly carried out. In addition, in the above-mentioned processing shown in FIGS. 7 and 8A to 8C, it is necessary to detect the idle areas of the first and second spare areas by reproducing the data blocks in the first and second lead-in areas. However, when the spare area is provided at every session, the idle area of the spare area for the corresponding session can be detected by reproducing only the block data of the lead-in for the corresponding session. Hence, the processing operation can be simplified.

Note that even in such a case, as described in the second embodiment, there may also be adopted such processing that it is determined whether or not a spare area can be secured based on the storage capacity (recordable capacity) remaining in the disc and the capacity (storage data capacity) of data to be stored in the disc, and when it is determined that the spare area can be secured, the spare area is secured. In addition, as described in the above-mentioned embodiment mode, the spare area may be secured in order from the most outer periphery of the disc.

It should be noted that for the embodiment mode of the present invention, various changes may be suitably made within the range of the technical idea shown in the scope of claims.

1. An information recording and reproducing device for recording and reproducing information in and from a write once type recording medium, comprising:
recording means for recording information in the write once type recording medium;
reproducing means for reproducing information from the write once type recording medium;
propriety determination means for determining propriety of recording based on a reproducing state when the information recorded by the recording means is reproduced by the reproducing means;
instruction detection means for detecting an instruction indicating to secure a spare area;
spare area securing means for, when the recording is determined as being improper by the propriety determination means and when the instruction to secure the spare area is detected by the instruction detection means, securing a spare area; and
recording control means for, when the recording is determined as being improper by the propriety determination means and when the instruction to secure the spare area is detected by the instruction detection means, spare-recording the information the recording of which is determined as being improper in the spare area secured by the spare area securing means,
wherein the spare area securing means secures the spare area in an area where interchangeability on a format with a reproducing dedicated type recording medium can be maintained.

2. An information recording and reproducing device according to claim 1, wherein when data reproduced by the reproducing means cannot be reproduced, or when an amount of error equal to or larger than a reference value is contained in information reproduced by the reproducing means, the propriety determination means determines that the recording is improper.

3. An information recording and reproducing device for recording and reproducing information in and from a write once type recording medium, comprising:
recording medium for recording information in the write once type recording medium;
reproducing means for reproducing information from the write once type recording medium;
error correction means for performing error-correction on the information reproduced by the reproducing means;
propriety determination means for determining propriety of recording based on a reproducing state when the information recorded in the write once type recording medium is reproduced by the reproducing means;
instruction detection means for detecting an instruction indicating to secure a spare area;
spare area securing means for, when the recording is determined as being improper by the propriety determination means and when the instruction to secure the spare area is detected by the instruction detection means, securing a spare area; and
recording control means for, when the recording is determined as being improper by the propriety determination means and when the instruction to secure the spare area is detected by the instruction detection means, spare-recording the information obtained by performing error-correction on the information the recording of which is determined as being improper in the spare area secured by the spare area securing means,
wherein the spare area securing means secures the spare area in an area where interchangeability on a format with a reproducing dedicated type recording medium can be maintained.

4. An information recording and reproducing device according to claim 3, wherein when an amount of error equal to or larger than a reference value is contained in information reproduced by the reproducing means, and the error in the reproduced information can be corrected by the error correction means, the propriety determination means determines that the recording is improper.

5. An information recording and reproducing device according to any one of claims 1 to 4, wherein the spare area securing means determines whether or not the spare recording can be carried out for a spare area which is newly secured or which is already secured, and when it is determined that the spare recording cannot be carried out for the spare area, secures a new spare area in an area where interchangeability on a format with a reproducing dedicated type recording medium can be maintained.

6. An information recording and reproducing device according to any one of claims 1 to 4, wherein when a plurality of medium structures are realized on the write once type recording medium, the spare area securing means secures an individual spare area for each medium structure.

7. An information recording and reproducing device according to any one of claims 1 to 4, wherein the spare area securing means determines whether or not the spare area can be secured based on an unrecorded area capacity of the write once type recording medium and a capacity of recording information to be recorded, and when it is determined that the spare area can be secured, secures the spare area.

8. An information recording and reproducing device according to any one of claims 1 to 4, wherein the spare area securing means gradually secures the spare area by predetermined capacity from a end side of an area where information can be additionally recorded.

9. An information recording and reproducing device according to any one of claims 1 to 4, wherein the recording control means records defect management information representing a correlation between a spare source recording position and a spare destination recording position in an area where interchangeability on a format with a reproducing dedicated type recording medium can be maintained.
